(19) United States
(12) Patent Application Publication
(10) Pub. No.: US 2021/0331360 A1
(43) Pub. Date: Oct. 28, 2021

(54) DYNAMICALLY TEMPERATURE-CONTROLLED IN-MOULD DECORATION

(71) Applicant: Covestro Intellectual Property GmbH & Co. KG, Leverkusen (DE)

(72) Inventors: Roland Kuenzel, Leverkusen (DE); Peter Capellen, Krefeld (DE); Thomas Grimm, Köln (DE)

(21) Appl. No.: 17/272,991

(22) PCT Filed: Aug. 27, 2019
(86) PCT No.: PCT/EP2019/072735

§ 371 Date: Mar. 3, 2021

(30) Foreign Application Priority Data
Sep. 10, 2018 (EP) 18193377.1

(51) Int. Cl. B29C 45/14; B32B 17/10; B29C 45/73; B29C 45/78

(52) U.S. Cl. CPC B29C 45/14688; B32B 17/10; B29C 45/73; B29K 2069/00; B29C 2045/14696; B29C 2945/76531; B29C 2945/76735; B29C 45/78

(57) ABSTRACT

The invention relates to an injection-molding process for the production of an injection-molded element, comprising a film element and an in-mold-coating layer directly injected onto said element. The film element occupies only part of the area of the in-mold-coating layer, and therefore at least one portion of the film edges of said film element is located in the middle of the relevant area of the injection-molded element. In order to avoid notching in the boundary region, the process for the production of the injection-molded element utilizes dynamic temperature control for locally restricted heating of the mold in the region where the flow front of the in-mold-coating material encounters the film material. Injection-molded elements are thus obtained in which no optically discernible boundary is present between film element and in-mold-coating layer. Because there are no joints, the injection-molded elements are amenable to successful and durable subsequent coating.

The present invention relates to a process for the production of an injection-molded element with a frontal side and a reverse side, where there is, arranged on the front side of the injection-molded element, a film element flush with the surface of an in-mold-coating layer. The invention further relates to an injection-molded element obtainable by the process, and also to a mold for the conduct of the process.

Injection moldings are conventionally equipped with films for additional functionalities. By way of example, glazing elements made of plastics material are provided with heating films in order to permit easy, convenient thawing of windshields/cladding elements in winter, for example in the case of windshields and rear windows, or front and rear panels, for vehicles.

In the case of transparent injection moldings, the film has hitherto preferably been applied on the reverse side of the injection molding. There are several reasons for this: This often provides an attractive optical depth effect. If the film has been applied only in a partial region, it is easier to conceal the film edge on the reverse side of the injection molding. Another possibility is that particles which would lead to defects during subsequent outer coating of the visible side—defects which can even be caused by the finest dust particles—adhere on the film; this is an additional reason for provision of the film on the reverse side of the injection molding. As a general rule, a very major challenge in the case of optical applications is cleaning of the film inserts before in-mold coating in order to avoid defects on the injection-molded item. The advantage of films used in partial regions of the in-mold-coating layer is that these have a smaller area than films extending across the entire area of the injection molding; this simplifies the handling of the film, in particular after the protected or laminated films have been peeled away, and reduces the risk of adherent particles. The use of partial films moreover provides the possibility of integrating a plurality of films with different functionalities within a component.

By way of example, in the case of glazing elements and coverings for sensor technology, in some cases in the past a heating film has been arranged across the entire area of the reverse side of the injection molding, as described by way of example in DE 102015004204 A1. Attachment in partial regions on the reverse side has also been described, for example in DE 102012105564 A1. However, arrangement on the reverse side is not particularly energy-efficient, and the thawing procedure requires a comparatively large amount of time. There is therefore a requirement for optimization in relation to the above. For certain types of ice covering and weather situation, and certain thicknesses of the covering plastics layer, when the heating film is positioned on the reverse side of the component the achievable heating power is also inadequate to permit thawing of the ice layer. In particular also for front panels in the automobile sector with integrated sensor technology, e.g. LiDAR sensors or radar sensors, therefore, the heating function is required at the external side of the component in order to keep the outer surface ice-free at low temperatures. It is therefore desirable here, and also in other applications for other reasons, to arrange the film on the front side of the injection molding, this being the side that is visible in the final application: the “visible side”.

When the film has been placed on the front side, i.e. the visible side, of the injection molding it has hitherto preferably been applied over the entire surface, so that the film edge is not discernible in the middle of the component surface. This would be problematic in particular in the case of glazing elements for vehicles, where the boundary could be within the driver's field of vision. However, attachment of the film over the entire surface has the disadvantage that for some component sizes the pieces of film required are also very large and correspondingly expensive. As film size increases, there is moreover increasing risk of scrap production, because of a large increase of complexity in the handling of the film and also of the difficulty of positioning of the film in the mold.

However, application of a film with a certain thickness, in a manner that is very locally restricted, i.e. does not involve the entire surface, implies boundaries that are visible, in particular after subsequent coating. If the intention is to integrate a functional film with a thickness of about 20 μm or more into a partial region of the visible side of an injection-molded element, there is the problem of resultant optical defects. There would be a residual gap in the boundary region between in-mold-coating layer, i.e. the layer made of injection-molded plastics material, and the semifinished product. In particular in the event of subsequent coating, this defect would be readily discernible, because in the notch region there would be disturbances to flow of the outer coating, in particular accumulations of outer coating, with the risk of cracking. Even without subsequent coating, this type of unevenness in the component surface is clearly apparent, however.

With the aim of nevertheless obtaining attractive injection moldings when a film does not cover the entire area, solutions have therefore in some cases been sought that, however, have not hitherto provided any actual solution of the problem, namely elimination of the unattractive boundary region between film and substrate material, but that instead have made use of the existing shortcoming, for example as described in EP 3 025 603 A1, where operations intentionally use a visual difference between the film and the remainder of the molding. The element that is in-mold coated here moreover already has a hardcoat, and there is therefore no requirement of any further subsequent outer coating that highlights uneven areas or boundaries. Subsequent application of the above type of outer coating could not moreover give a useful result of any kind, because a gap forms between the film insert and the molding, as described above.

It was therefore an object to provide an injection-molded element and a process for production thereof where a film element with a minimum thickness of 20 μm has been integrated in a partial region in a side thereof, preferably the visible side, and in which the boundary region between in-mold-coated layer and film element is almost impossible to discern by optical means and by touch, if possible being completely impossible to discern, and which therefore accordingly maximizes the possibility of defect-free outer coating.

The object is achieved in the invention via a process as claimed in claim 1, an injection-molded element as claimed in claim 10 and a mold as claimed in claim 13. Advantageous embodiments can be found in the dependent claims. They may be combined as desired unless the opposite is clear from the context.

A process for the production of an injection-molded element with a front side and a reverse side, where there is, arranged on the front side of the injection-molded element, a film element flush with the surface of an in-mold-coating layer,

where the film element has an edge and defines an inner edge region which extends from the edge over a predetermined distance d1 running at right angles to the edge in the direction of the film element, where d1 is smaller than half of the width of the film element
comprises the following steps in this sequence:
provision of a mold which in the closed state defines, between a first mold half which replicates the front side of the injection-molded element and a second mold half which replicates the reverse side of the injection-molded element, a cavity configured in a manner complementary to the injection-molded element,
placing of the film element into the first mold half,
closure of the mold,
injection of a plastified thermoplastic material into the cavity in order to configure an in-mold-film coating layer,
allowing the plastics material to solidify,
opening of the mold and
removal of the injection-molded element.

The thickness of the film element is ≥20 μm to ≤1000 μm (determined in accordance with DIN 53370:2006-11), and it covers only a partial region in the first mold half.

The words “the film element has an edge” here preferably mean an edge running around the entire film element, i.e. a completely surrounding edge, where “completely surrounding” refers to a plan view of the front side of the injection-molded element with film element in place. If the film element is directly in contact with the edge of the in-mold-coating layer, i.e. by way of example in the case of a rectangular film element only two or three of the sides lie “within” the in-mold-coating layer, it is preferable that only these sides and the edge portion located there form the inner and, respectively, the outer edge region.

The words “the film element defines an inner edge region” in turn preferably mean that said inner edge region is defined via the edge of the film element, and specifically as provided by the abovementioned width restriction. The words “the predetermined distance d1” here therefore indicate the width of said inner edge-region strip, which is in the region of the film area.

The words “the predetermined distance d1 running at right angles to the edge in the direction of the film element” here preferably simply mean that the inner boundary of the inner edge region runs parallel, in the plane of the film, to the edge of the film element. It is therefore possible in an embodiment to define simultaneously the boundary of the inner heating region and the distance that is to be taken into account in order to determine the width of the inner heating region.

At least during a portion of the injection of the plastified thermoplastic material at least the inner edge region of the film element is heated by one or more temperature-controlled elements present in the first mold half at least to a temperature T of 20° C. below the Vicat softening point (determined in accordance with DIN ISO 306:2014 method B at 120 K/h of heating time) of the material of the film element. Predetermined sections of the first mold half facing toward the cavity are heated, and other predetermined sections of the first mold half facing toward the cavity are not heated; the heating of the mold therefore takes place in locally restricted manner. Heating “during a portion of the injection” means that heating takes place at least temporarily during the injection procedure, preferably during the entire injection procedure.

The temperature T is preferably at least 15° C. below the Vicat softening point, more preferably at least 5° C. below the Vicat softening point. The temperature T is more preferably above or equal to the Vicat softening point of the material of the film element. The temperature is particularly preferably up to 40° C. (inclusive) above the Vicat softening point. Higher temperatures are less favored, for energy-related reasons and because of longer cycle times. In the case of a multilayer film element, these data refer to the Vicat point of the material of the supportive layer.

For the purposes of the present invention, the temperature T can be regarded as the temperature at the relevant regions of the wall of the first mold half. Dynamic temperature control can thus be achieved via temperature control of an injection mold. The heating can by way of example result from induction heating, ceramic heating, water heating, steam heating or electrical heating. It is preferable that after the heating procedure the first mold half is cooled again, for example to 120° C. or below or 80° C. or below.

Locally restricted heating of the mold is achieved in the process of the invention by means of what is known as dynamic temperature control at the film element/in-mold-coating material boundary, i.e. in the edge region of the film, where the flow front of the in-mold-coating material encounters the film element. An injection-molding cycle generally involves rapid heating of the mold wall at the relevant location to the target temperature and then rapid cooling. Dynamic temperature control has not hitherto been used for this purpose. Dynamic temperature control, meaning swift heating of the mold wall before injection of the melt and, after the injection procedure, reducing the temperature of the mold wall as swiftly as possible, has hitherto been used only with two melts to prevent premature solidification, so as to obtain good bonding and a good surface and thus to increase the precision of replication of the mold surface, or so as to fill microstructured surfaces, or so as to achieve high-loss surfaces with filled thermoplastics.

It was surprising that the present invention results in an effect, although this does not consist in avoidance of the discernible boundary between two flow fronts, i.e. a weld seam, but instead consists in the ability, by the abovementioned method, to avoid boundaries between an element introduced as solid into the mold and a thermoplastic melt that serves for in-mold coating. The bonding between the film element and the in-mold-coating material in the injection-molded element is fully satisfactory for optical purposes, with no air inclusions, with no significant distortion, and with no over- or underflow around the film; there is no inhomogeneity in the boundary region between film and in-mold-coating material.

The abovementioned method provides injection-molded elements which have film element integrated on the front side of the injection-molded element and in which the film edge is not discernible although it is in the middle of the area of the injection-molded element. The surface, inclusive of that side of the injection-molded element into which the film element has been integrated, is smooth, with no notching, i.e. jointless, and therefore “flush”, therefore being amenable to very successful subsequent coating, in particular outer coating. It is no longer necessary to cover the entire relevant side of a component with a film in order to avoid discernible film edges in the injection molding. The process is comparatively inexpensive, because the required energy consumption is relatively small and the necessary area of film is relatively small.

The “front side of the injection-molded element” in the process is preferably the visible side of the components, i.e. the side that is visible in the final use of the component, which can have been installed into a housing or, for example, integrated within a vehicle.

The film element covers only a partial region in the first mold half. The film does not then cover the entire surface of the in-mold-coating layer. The film element can have been placed in the edge region of the injection-molded element, e.g. directly adjoining the edge of the injection-molded element, but can also be in the middle of the substrate layer. The positioning of the film element is not in principle subject to any restriction.

There are various possibilities known for fixing the film element in the mold cavity. Technologies commonly used here are inter alia electrostatic charging, vacuum and manual retention lugs.

In the case of rectangular film elements the width of the film element is, as in the conventional definition, the dimension of the shorter side of the rectangle. In the case of non-rectangular film elements, a smallest-possible surrounding rectangle (“bounding box”) is placed around these, and the width of this rectangle is used as reference dimension.

It is of course also possible to integrate more than one film element into the injection-molded element, and in this case it is preferable that, in order to avoid visible boundaries or indeed notches or subsequent defects in an outer coating, locally restricted heating of the mold in the region of the film edge takes place for each film element in the production process for the injection-molded element.

In relation to the film element, the meaning of the thickness provided in the invention is preferably that the film element has this thickness over the entire area. Minimal manufacturing tolerances of course imply the same thickness. The front side (i.e. visible side) and reverse side of the film are therefore in essence planes that are parallel, preferably planes that are parallel, to one another.

The film element can be composed of a single-layer film made of an appropriate thermoplastic composition, comprising one or more thermoplastic polymers and optionally other additives.

The film element can alternatively also be composed of a multilayer film, where at least one layer is composed of a thermoplastic composition, comprising one or more of the thermoplastic polymers mentioned and optionally other additives. The one or more further layers in the multilayer structure can have been applied by way of example by coextrusion, lamination and/or coating processes, for example wet-coating processes or plasma-coating processes.

Also suitable as film material are thermoplastic-based coextruded film structures and composites.

The film element can be smooth or have a surface structure applied to one or both sides of the film.

The size of the film element is preferably 100 mm² to 2 250 000 mm², more preferably 500 mm² to 1 000 000 mm² and particularly preferably 1000 mm² to 500 000 mm².

In order to compensate for expansion of films or displacement of films due to softening of the film at increased temperatures, it is preferable that, in particular when there is a print on the film element, the film element is larger than required by the respective desired function.

The proportion of the visible film area, i.e. of that portion of the film that faces toward the external side of the injection-molded element, based on the total area of the injection-molded element on the side intended to be the visible side of the component, is preferably 0.5 to 90%, more preferably 1 to 80%, particularly preferably 2 to 70%, very particularly preferably 3 to 60%, most preferably 5 to 60%.

The in-mold-coating material can be transparent, translucent or opaque. The same thermoplastic polymers, alone or in a mixture, and compositions thereof, comprising conventional additives, used in the film material are in principle also suitable for the in-mold-coating component. It is preferable that the material of the in-mold-coating layer is transparent. For the purposes of the present invention, the word “transparent” means materials whose luminous transmittance in the VIS region of the spectrum (380 to 780 nm) is above 3% (TVIS transmittance), determined in accordance with DIN ISO 13468-2:2006 (D65, 10°, sample plate thickness: 4 mm), and whose haze is preferably below 10%, determined in accordance with ASTM D1003:2013, based on the respective substrate layer at all locations within its extent. The intended meaning here is in particular materials which exhibit visual transparency, i.e. clearly reveal what is behind them.

The average layer wall thickness of the in-mold-coating component in the region of overlap with the film is preferably 0.5 mm to 10 mm, more preferably 1 mm to 8 mm, particularly preferably 1.5 to 6 mm. The word “average” signifies that the in-mold-coating layer, which in the invention is understood to be the layer made of the in-mold-coating material, i.e. the layer produced by direct in-mold coating of the film, does not necessary have the same thickness over the entire area of the film, but instead can also have different thicknesses, for example through formation of reinforcement ribs, or because of the component shape, or because of fastening structures, etc. However, it is preferable that the layer wall thickness of the in-mold-coating component in the region of overlap with the film is identical at each location of the region of overlap, and that therefore the average layer wall thickness corresponds to the actual layer wall thickness of the in-mold-coating component at all locations of the region of overlap.

The process of the invention is suitable for a wide variety of applications which have functional films integrated into partial regions of the front side of injection moldings. Examples of corresponding injection-molded elements which, by virtue of their superior jointless, optically high-quality appearance, as likewise provided by the present invention are glazing elements with integrated heating films, front panels such as radiator grilles, and also closed front panels of the type used in electrical vehicles, and also rear, side or roof panels of vehicles, in particular of automobiles, for sensor-technology applications. The abovementioned elements for, for example, LiDAR applications and/or camera applications likewise have a heating film in the visible (sensor) region, and therefore only in a partial region, in order to ensure that the sensors can also function in weather conditions that cause formation of ice.

Examples of suitable material for the film element and for the in-mold-coating layer are, mutually independently, ABS, AMMA, ASA, CA, CAB, COC, EP, UF, CF, MF, MPF, PF, PAN, PA, PE, HDPE, LDPE, LLDPE, PEI, PC, PET, PMMA, PP, PS, SB, PUR, PVC, RF, SAN, PBT, PPE, POM, PP-EPDM, UP, TPU (abbreviations in accordance with DIN EN ISO 1043-1:2002-06), and also mixtures of these and compositions of these, comprising conventional additives. The materials for film element and in-mold-coating layer can be identical, selected from the same substance class (for example two polycarbonates), or selected from different substance classes. Composite films composed of two or more layers of the abovementioned plastics layers are suitable for the film element.

Preference is given to the following as material for the film element and for the in-mold-coating layer: thermoplastic polyurethanes, polymethyl methacrylate (PMMA), and also modified PMMA variants, cycloolefin copolymers, aromatic polycarbonate (PC), inclusive of copolycarbonate (Co-PC), polyetherimide, styrene-acrylonitrile, acrylonitrile-styrene-acrylate copolymers (ASA), acrylonitrile-butadiene-styrene copolymers (ABS), polyester—in particular/aromatic polycarbonate-blends or ABS/aromatic polycarbonate blends or compositions of these. Particular preference is given to aromatic polycarbonate, inclusive of copolycarbonate, polymethyl methacrylate, styrene-acrylonitrile, cycloolefin copolymers, polyetherimide and compositions of these, and very particular preference is given to aromatic polycarbonate, ABS/polycarbonate and/or polybutylene terephthalate/polycarbonate blends and compositions of these.

The process is in particular suitable for the combination of a film based on aromatic polycarbonate with in-mold-coating material based on aromatic polycarbonate, and likewise for the combination of a film based on polymethyl methacrylate with material based on polymethyl methacrylate for in-mold coating. The meaning of the words “based on” here is that the proportion of the polymer in the entire composition of the respective material is at least 50% by weight, preferably at least 55% by weight, more preferably at least 60% by weight.

In an embodiment of the process, the thermoplastic material and/or the material of the film element comprise(s) a polycarbonate. It is preferable that the polycarbonate of the thermoplastic material and of the film element is an aromatic polycarbonate.

The words aromatic “polycarbonate” in the invention mean either homopolycarbonate or copolycarbonate. The polycarbonates here can, in known manner, be linear or branched. It is also possible in the invention to use mixtures of polycarbonates.

A portion of up to 80 mol %, preferably of 20 mol % to 50 mol %, of the carbonate groups in the polycarbonates used in the invention may be replaced by aromatic dicarboxylic ester groups. Polycarbonates of this type that have not only acid moieties derived from carbonic acid but also acid moieties derived from aromatic dicarboxylic acids incorporated into the molecular chain are termed aromatic polyester carbonates. For the purposes of the present invention, they are subsumed within the umbrella term “thermoplastic aromatic polycarbonates”.

Replacement of the carbonate groups by the aromatic dicarboxylic ester groups is in essence stoichiometric, and also quantitative, and the molar ratio of the reactants is therefore also maintained in the final polyester carbonate. The aromatic dicarboxylic ester groups can be incorporated either randomly or blockwise.

The thermoplastic polycarbonates, inclusive of the thermoplastic aromatic polyestercarbonates, have average molecular weights Mw, determined by means of gel permeation chromatography in accordance with DIN 55672-1:2007-08, calibrated against bisphenol A polycarbonate standards with use of dichloromethane as eluent, of 10 000 g/mol to 35 000 g/mol, preferably of 12 000 g/mol to 32 000 g/mol, more preferably of 15 000 g/mol to 32 000 g/mol, especially of 20 000 g/mol to 31 500 g/mol, calibration with linear polycarbonates (derived from bisphenol A and phosgene) of known molar mass distribution from PSS Polymer Standards Service GmbH, Germany, and calibration in accordance with method 2301-0257502-09D (2009 edition in German language) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Detection with use of a refractive index (RI) detector.

Details of the production of polycarbonates have been set out in many patent specifications during the last approximately 40 years. Reference may be made here for example to Schnell, “Chemistry and Physics of Polycarbonates”, Polymer Reviews, Volume 9, Interscience Publishers, New York, London, Sydney 1964, and to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch [Plastics handbook], vol. 3/1, Polycarbonate, Polyacetale, Polyester, Celluloseester [Polycarbonates, polyacetals, polyesters, cellulose esters], Carl Hanser Verlag Munich, Vienna 1992, pages 117-299.

Preferred modes of production of the polycarbonates to be used in the invention, including the polyester carbonates, are the known interfacial process and the known melt transesterification process (cf. e.g. WO 2004/063249 A1, WO 2001/05866 A1, U.S. Pat. Nos. 5,340,905 A, 5,097,002 A, 5,717,057 A).

Aromatic polycarbonates are produced and effected for example by reaction of dihydroxyaryl compounds with carbonic halides, preferably phosgene, and/or with aromatic diacyl dihalides, preferably dihalides of benzenedicarboxylic acids, by the interfacial process, optionally using chain terminators and optionally using trifunctional or more than trifunctional branching agents, where for the production of the polyester carbonates a portion of the carbonic acid derivatives is replaced by aromatic dicarboxylic acids or derivatives thereof in accordance with the extent to which the carbonate structural units are to be replaced by aromatic dicarboxylic ester structural units in the aromatic polycarbonates. Production by way of a melt polymerization process is also possible, by reaction of dihydroxyaryl compounds with, for example, diphenyl carbonate.

Dihydroxyaryl compounds suitable for producing polycarbonates are those of formula (1)

HO—Z—OH (1),

in which
Z is an aromatic moiety which has 6 to 30 carbon atoms and may comprise one or more aromatic rings, and may be substituted and may comprise aliphatic or cycloaliphatic moieties or alkylaryl moieties or heteroatoms as bridging elements.
Z in formula (1) is preferably a moiety of formula (2)

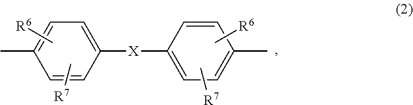

in which
R⁶ and R⁷ are mutually independently H, C₁- to C₁₈-alkyl-, C₁- to C₁₈-alkoxy, halogen such as Cl or Br or respectively optionally substituted aryl or aralkyl, preferably H or C₁- to C₁₂-alkyl, particularly preferably H or C₁- to C₈-alkyl and very particularly preferably H or methyl, and
X is a single bond, —SO₂—, —CO—, —O—, —S—, C₁- to C₆-alkylene, C₂- to C₅-alkylidene or C₅- to C₆-cycloalkylidene, which may have substitution by C₁- to C₆-alkyl, preferably methyl or ethyl, or else C₆- to C₁₂-arylene, optionally fused to further aromatic rings comprising heteroatoms.
   X is preferably a single bond, C₁- to C₅-alkylene, C₂- to C₅-alkylidene, C₅- to C₆-cycloalkylidene, —O—, —SO—, —CO—, —S—, —SO₂—
   or a moiety of the formula (2a)

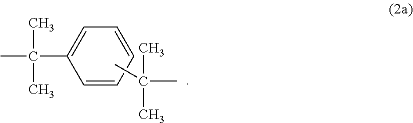

Examples of dihydroxyaryl compounds suitable for the production of polycarbonates are hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives, and the related ring-alkylated, ring-arylated and ring-halogenated compounds.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane dimethyl bisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

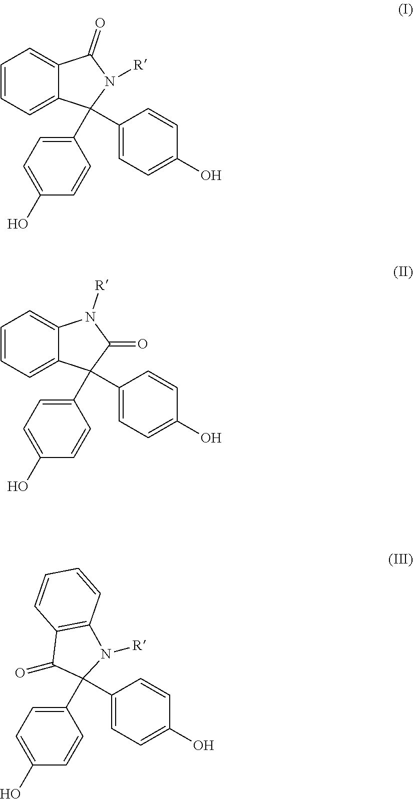

in which R′ is respectively C₁- to C₄-alkyl, aralkyl or aryl, preferably methyl or phenyl, very particularly preferably methyl.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A and also the diphenols of formulae (I), (II) and (III).

These and other suitable dihydroxyaryl compounds are described by way of example in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates only one dihydroxyaryl compound is used; in the case of copolycarbonates multiple dihydroxyaryl compounds are used. The dihydroxyaryl compounds used, and also all of the other chemicals and auxiliaries added to the synthesis, can have contamination by contaminants deriving from their own synthesis, handling and storage. However, it is desirable to use raw materials of the highest possible purity.

Examples of suitable carbonic acid derivatives are phosgene and diphenyl carbonate.

Suitable chain terminators that may be used in the preparation of the polycarbonates are monophenols. Examples of suitable monophenols are phenol itself, alkylphenols such as cresols, p-tert-butylphenol, cumylphenol, and also mixtures of these.

Preferred chain terminators are the phenols which have substitution by one or more linear or branched, preferably unsubstituted, C₁ to C₃₀-alkyl moieties, or by tert-butyl. Particularly preferred chain terminators are phenol, cumylphenol and/or p-tert-butylphenol.

The quantity of chain terminator to be used is preferably 0.1 to 5 mol %, based on the number of moles of diphenols respectively used. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The quantity of the branching agents optionally to be used is preferably 0.05 mol % to 2.00 mol %, based on the number of moles of dihydroxyaryl compounds respectively used.

The branching agents can form an initial charge with the dihydroxyaryl compounds and the chain terminators in the aqueous alkaline phase or can be added, dissolved in an organic solvent, before the phosgenation. In the case of the transesterification process, the branching agents are used together with the dihydroxyaryl compounds.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane, and also homo- or copolycarbonates derived from the diphenols of formulae (I), (II) and/or (III)

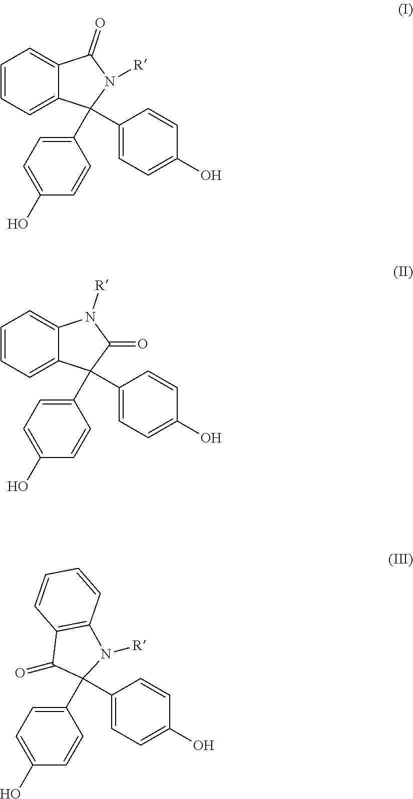

in which R′ respectively is C₁- to C₄-alkyl, aralkyl or aryl, preferably methyl or phenyl, very particularly preferably methyl, in particular with bisphenol A.

The MVR of the polycarbonate is preferably 5 to 20 cm³/(10 min), more preferably 5.5 to 12 cm³/(10 min), still more preferably up to 8 cm³/(10 min), determined in accordance with ISO 1133:2012-03 at a test temperature 300° C. with a load of 1.2 kg.

The film material can, of course, comprise not only the thermoplastic polymer but also additives and/or processing aids related to film production (“its composition”), examples being light stabilizers and other stabilizers, plasticizers, and fillers such as fibers, and dyes. The same applies to the material of the in-mold coating layer.

In another embodiment of the process, regions of the film element that do not belong to the inner edge region are not heated to the temperature T. It is thus possible to save energy in the process.

In particular in the case of small film elements, for energy-related reasons in another embodiment the locally restricted heating preferably extends only to those regions in which the boundary of flow front of the in-mold-coating material/film element and optionally the film element is present.

In another embodiment of the process, the temperature T is at most 80° C. above the Vicat softening point (determined in accordance with DIN ISO 306:2014 method B at 120 K/h of heating time) of the material of the film element.

In another embodiment of the process, the predetermined distance d1 is ≥1% to ≤40% of the width of the film element. d1 is preferably ≥2% to ≤30% of the width of the film element, more preferably ≥3% to ≤10% of the width of the film element.

In another embodiment of the process, the film element moreover defines an outer edge region which extends from the edge over a predetermined distance d2 running at right angles to the edge in the direction away from the film element, where d2 is ≥1% to ≤40% of the width of the film element, and where, in the first mold half, sections corresponding to the outer edge region are heated together with the inner edge region to the temperature T. d2 is preferably ≥2% to ≤30% of the width of the film element, more preferably ≥3% to ≤10% of the width of the film element.

The film element used can be an uncoated element, or can have undergone single or multiple functionalization on one or both sides. The functionalization can be achieved via
coating, for example wet coating (for example a roll-to-roll process) or a plasma process,
printing, for example: screen printing, inkjet, tampon printing, intaglio printing or offset,
lamination (single- or multilayer),
embossing,
coextrusion (single- or multilayer),
coloring,
provision of additives (for example light-scattering pigments, diffusor additives, IR absorbers, UV absorbers or antistatic agents)
   or by a combination of various functionalization processes.

Non-restrictive examples of functionalization can be:

A) Protection of the surface (for example scratch-protection, weathering resistance or chemicals resistance)
B) Application of decorative effects (for example colors, structures, markings or inscriptions)
C) Application of functionalities (for example antireflective, easy-to-clean, hydrophobic, temperature-control elements, reflective layers or contact arrangements)
D) Adhesion-promoting layers.

It is possible to combine a plurality of functionalizations.

A very wide variety of functions can be present in the film element(s) used; a plurality of film elements per injection-molded element can also provide various functions. A single film element can also simultaneously have a plurality of functions. Possible functions of the film are provision of local projection areas, provision of local scattering areas, introduction of colored regions, introduction of surface structures, additive functionalization, e.g. locally switchable transparency or color, introduction of an anti-fingerprint function, antireflective function, antiglare function, antifogging function, introduction of defined haptic properties, local increase of the chemical resistance of the surface, introduction of a barrier function, introduction of IR reflectivity, introduction of IR-absorption properties; the film can moreover have functions by way of surface metallization procedures and/or layers applied by way of plasma (for example decorative layers, e.g. chromium, aluminum; conductive coatings, IR reflection; heating systems), or can be a polarizing film, for example for a display cover, or can be a super retardation film which eliminates rainbow colors due to polarization in displays, and can have other functions that can be introduced into a film by way of additives, polymer properties or surface properties or surface characteristics.

In another embodiment of the process, therefore, the film element is a heating film, a film with projection function, a film with scattering function, a colored film, a film with optically discernible surface structure, a film comprising functional additives, a film with antireflective function, a film with anti-fingerprint function, a film with antiglare function, a film with antifogging function, a film with increased chemical resistance to the in-mold-coating material, a film with barrier function, an IR-reflective film, a film with absorption properties, a polarizing film, a metallized film and/or a super retardation film.

In another embodiment of the process, the thickness of the film element is ≥100 μm to ≤700 μm. More preference is given to thicknesses of ≥150 μm to ≤500 μm, and still greater preference is given to those of ≥175 μm to ≤375 μm.

In another embodiment of the process, after removal of the injection-molded element, a coating composition is then used for subsequent coating of at least the component side on which the film element is present. It is also possible, of course, to apply a plurality of layers of different coating compositions.

A subsequent coating is usually intended to provide mechanical protection from abrasion and scratching and/or protection from effects of weathering, i.e. rain, temperature variation and UV radiation.

Systems for subsequent coating of, for example, injection-molded elements based on aromatic polycarbonate, in particular in combination with a film element based on aromatic polycarbonate, can be broadly divided into three categories:

(a) Thermoset coating systems based on an outer polysiloxane coating; these can be either single-layer systems or multilayer systems (with, between substrate and polysiloxane topcoat, a primer layer merely for adhesion-promoting purposes). These are described inter alia in U.S. Pat. Nos. 4,278,804 A, 4,373,061 A, 4,410,594 A, 5,041,313 A and EP 1 087 001 A2. Examples mentioned here are the commercially obtainable systems from Momentive Performance Materials Inc. Wilton, Conn. USA, for example PHC 587; PHC 587B, PHC 587C; PHC 587 C2 SHP 401 (primer)/AS 4000 (topcoat) and also SHP 401 (primer)/AS 4002 (topcoat), and also—KASI Flex® and Sun Flex®, both from KRD Coatings, Geesthacht, Germany, and Silvue® MP 100, SDC Coatings, Germany, and Sicralan® MRL from GFO, Schwabisch Gmünd, Germany.

It is additionally possible here that an adhesion-promoting primer layer is present which comprises an adhesion-promoting polymer and at least one, or more, UV absorbers but which because of the complete absence of UV absorbers or because of a low concentration of UV absorber in combination with inadequate layer thickness cannot provide weathering resistance. Other components could moreover optionally be present in the adhesion-promoting primer layer. The thickness of such a primer layer is in the range of about 0.3-1.5 μm.

(b) However, coating systems of the above type do not have adequate weathering-resistance for some applications. Improved systems have been developed here in order to achieve longer lifetime of the components. A successful variant is the use of the adhesive primer that is necessary for the siloxane-based topcoat in the form of a UV-protection primer when said primer is mixed with a UV absorber and applied with a relatively high layer thickness:
thermosetting multilayer systems with a UV-protection primer and a topcoat based on a outer polysiloxane coating. Suitable systems are known by way of example from U.S. Pat. Nos. 5,391,795 and 5,679,820 and “Paint & Coating Industry; July 2001, pp. 64 to 76: The Next Generation in Weatherable Hardcoats for Polycarbonate” by George Medford/General Electric Silicones, LLC, Waterford, N.Y.; James Pickett/The General Electric Co., Corporate Research and Development, Schenectady, N.Y.; and Curt Reynolds/Lexamar Corp., Boyne City, Mich. A commercially obtainable system, mentioned therein, is SHP470 (UV-protection primer)/AS4700 (docket) system from Momentive Performance Materials. This SHP470 primer is an adhesion item promoting UV-protection primer based on polymethyl methacrylate inter alia with 1-methoxy-2-propanol and diacetone alcohol as solvent and dibenzoylresorcinol as UV absorber. AS4700 topcoat is a polysiloxane topcoat with silylated UV absorber. Other suitable systems are those described in WO 2009/049904, comprising
a) 100 000 parts by weight of a primer composition suitable as adhesion promoter between a thermoplastic substrate and a siloxane-based topcoat, comprising binder material (a1), solvent (a2), and UV absorber (a3);
b) 0 to 900 000 parts by weight of a solvent, and
c) 1 to 3000 parts by weight of a compound of the formula (3):

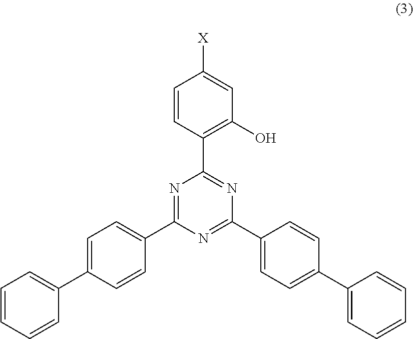

where X=OR6, OCH₂CH₂OR6, OCH₂CH(OH)CH₂OR6 or OCH(R7)COOR8, in which
R6=branched or unbranched C₁- to C₁₃-alkyl, C₂- to C₂₀-alkenyl, C₆- to C₁₂-aryl or —CO—C₁- to C₁₈-alkyl,
R7=H or branched or unbranched C₁- to C₈-alkyl, and
R8=C₁- to C₁₂-alkyl; C₂- to C₁₂-alkenyl or C₅- to C₆-cycloalkyl,
where the viscosity of the composition is 40 sec to 140 sec, measured in accordance with DIN EN ISO 2431:2012-03 at 23° C. and with a flow cup with a nozzle of diameter 2 mm.

Both layers, i.e. primer layer and topcoat layer, together assume the UV protection function here.

(c) UV-curing coating systems, for example based on acrylate, on urethane acrylate or on acryloylsilane, and optionally including fillers for improving scratch resistance, can likewise provide sufficient protection from weathering, because they have a relatively wide application layer thickness range. Such systems are known and are described inter alia in U.S. Pat. Nos. 3,707,397 A or DE 69 71 7959 T2, 5,990,188 A, 5,817,715 A, 5,712,325 A, and WO 2014/100300 A1. Examples of a suitable coating of this type are the commercially obtainable coating systems UVHC 3000, UVHC 3000K, UVHC 3000S and UVHC 5000 and modified forms of these, systems from Momentive Performance Materials, and UVT 200, UVT 610 and UVT 820 and modified forms of these, coating systems from Redspot.

The weathering-resistant scratch-protection layers (a) mentioned here, and the highly weathering-resistant scratch-protection layers (b) and (c), are also used on substrates made of other thermoplastics, for example polycarbonate blends.

The primer layers and topcoat layers can be applied by way of flow-coating or spraying processes. Particular preference is given to the flow-coating process (“flow-coating”) because of the resultant high optical quality. The flow-coating process can be carried out manually with a hose or suitable coating head or automatically in a continuous procedure by way of flow-coating robots and optionally slot dies. The components may be coated here either while suspended or while mounted in an appropriate holder. In the case of relatively large and/or three-dimensional components, the part to be coated is placed in a suitable product holder or suspended therein.

In the case of small-scale components, the coating procedure can also be carried out manually. In this procedure, the liquid primer solution or liquid outer coating solution that is respectively to form the additional layer is poured over the sheet in longitudinal direction starting from the upper edge of the small part while at the same time the point of application of the outer coating on the sheet is moved from left to right across the width of the sheet. The outer-coated sheets are air-dried and cured in accordance with the respective manufacturer instructions while hanging vertically from a clamp.

Spray coating can be carried out by manual methods using conventional spray guns, or by automated systems.

The invention further provides an injection-molded element, obtainable by a process of the invention, with a front side and a reverse side, where there is, arranged on the front side of the injection-molded element, a film element flush with the surface of an in-mold-coating layer, where the film element covers only one portion of the surface of the in-mold-coating layer, and where the film element and the in-mold-coating layer respectively comprise a thermoplastic polymer.

The thickness of the film element here is ≥20 μm to ≤1000 μm (determined in accordance with DIN 53370:2006-11), preferably ≥100 μm to ≤700 μm, particularly preferably ≥175 μm to ≤375 μm, and bonding of the film element to the in-mold-coating layer is jointless or in the event that a joint is present between film element and in-mold-coating layer, the depth of film of this joint is ≤12% (preferably ≤5%, more preferably ≤3%) of the thickness of the film element and/or the width of said joint is ≤12% (preferably ≤5%, more preferably ≤3%) of the thickness of the film element.

For the avoidance of repeated passages, we refer to information provided above relating to thermoplastic polymers, which is likewise applicable to the injection-molded element of the invention.

In an embodiment of the injection-molded element, the film element and the in-mold-coating layer respectively comprise a polycarbonate. For the avoidance of repeated passages, we refer to information provided above relating to polycarbonates, which is likewise applicable to the injection-molded element of the invention.

In another embodiment of the injection-molded element, the film element is a heating film, a film with projection function, a film with scattering function, a colored film, a film with optically discernible surface structure, a film comprising functional additives, a film with antireflective function, a film with anti-fingerprint function, a film with antiglare function, a film with antifogging function, a film with increased chemical resistance to the in-mold-coating material, a film with barrier function, an IR-reflective film, a film with absorption properties, a polarizing film, a metallized film and/or a super retardation film.

In another embodiment of the injection-molded element, the thickness of the film element is ≥100 μm to ≤700 μm. Preference is given to thicknesses of ≥150 μm to ≤500 μm, and more preference is given to those of ≥175 μm to ≤375 μm.

In another embodiment of the injection-molded element, a coating composition has been used for subsequent coating at least of the component side on which the film element is present. For the avoidance of repeated passages, we refer to information provided above relating to coating compositions, which is likewise applicable to the injection-molded element of the invention.

In another embodiment of the injection-molded element, the injection-molded element is a glazing element, a transparent covering or a cladding element, and the film element is a heating film. It is preferable that such a component comprising injection-molded element/film element is used in vehicles.

The invention further provides a mold which in the closed state defines, between a first mold half which replicates the front side of the injection-molded element and a second mold half which replicates the reverse side of the injection-molded element, a cavity configured in a manner complementary to the injection-molded element. The first mold half comprises one or more temperature-control elements equipped to heat predetermined sections of the first mold half facing toward the cavity, and where other predetermined sections of the first mold half facing toward the cavity are not heated.

The following figures provide more detail of the invention, which however is not restricted thereto. In the figures:

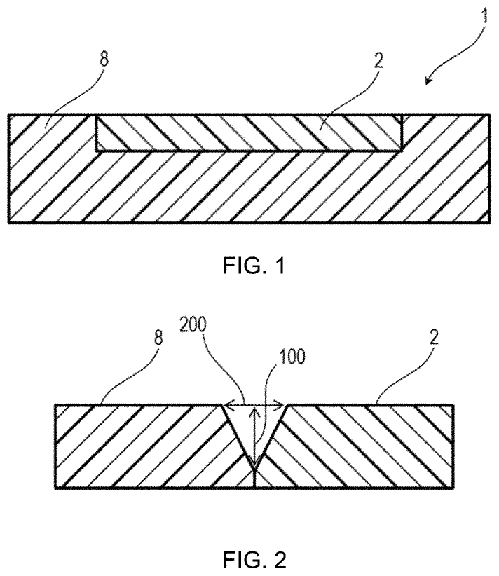

FIG. 1 shows a cross-sectional view of an injection-molded element of the invention

FIG. 2 shows a cross-sectional view intended to indicate certain dimensions in injection-molded elements

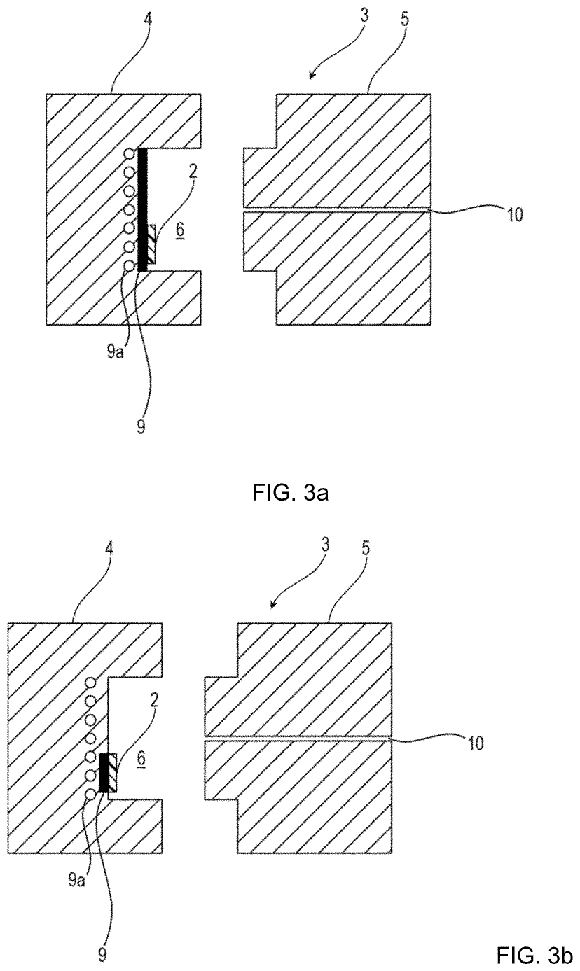

FIGS. 3a and 3b show initial phases in the process of the invention

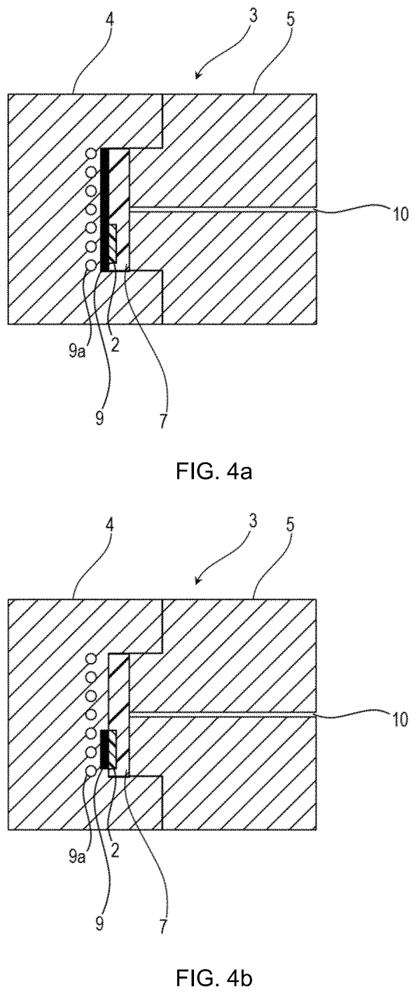

FIGS. 4a and 4b show second phases in the process of the invention

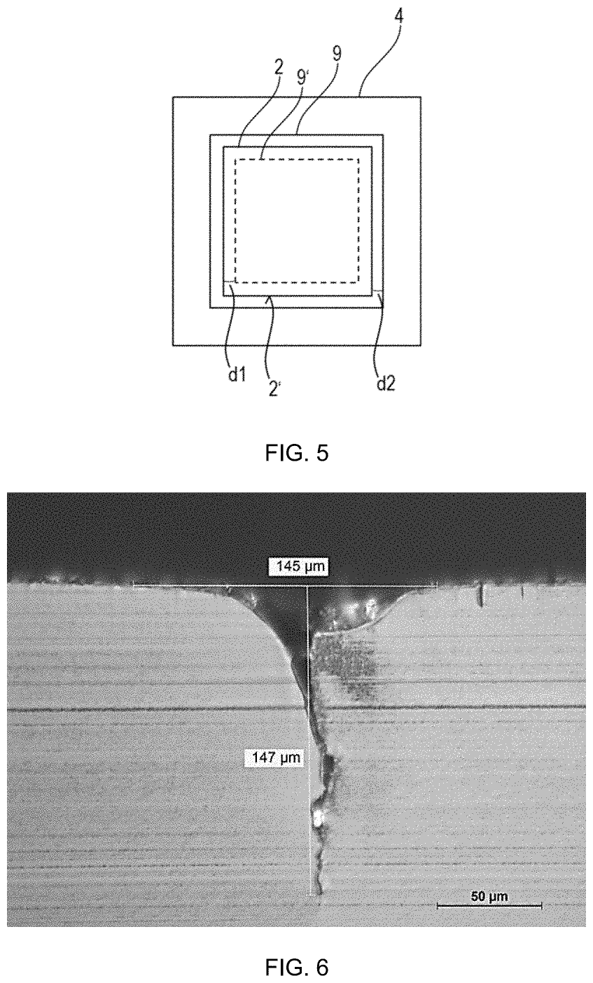

FIG. 5 shows a first mold half of a mold

FIG. 6 shows a micrograph of a comparative sample

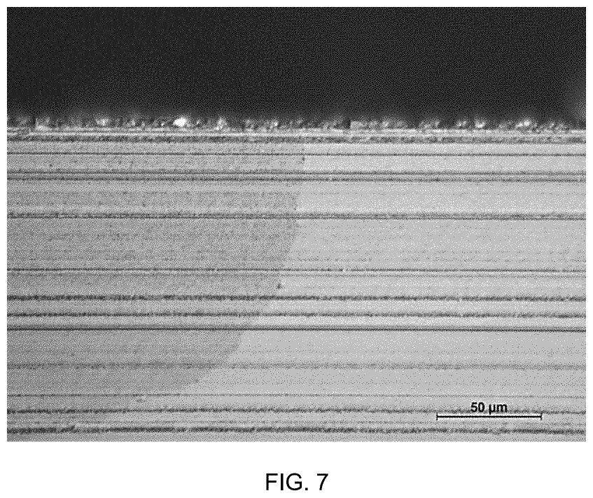

FIG. 7 shows a micrograph of a sample of the invention

FIG. 1 shows a diagrammatic cross-sectional view of an injection-molded element 1 of the invention with the film element 2 and the in-mold-coating layer 8. That side of the injection-molded element 1 on which the film element 2 is arranged is the front side of the injection-molded element 1 here. Accordingly, the side that is opposite to the film element 2 is the reverse side of the injection-molded element 1.

The film element 2 is arranged flush with the surface of the in-mold-coating layer 8, i.e. has been let into same in a manner such that on the front side of the injection-molded element 1 there are no height differences between the surfaces of the film element 2 and of the in-mold-coating layer 8 that form the front side of the injection-molded element. The film element has therefore been cut to a size that is smaller than the mold cavity surface. A tolerance range of height differences up to ±1 μm is also included.

FIG. 1 moreover shows that the film element 2 covers only one portion of the surface of the in-mold-coating layer 8. The in-mold-coating layer 8 therefore also forms one portion of the front side of the injection-molded element 1.

The invention provides that bonding of the film element 2 to the in-mold-coating layer 8 is jointless, or that any joint present does not exceed certain dimensions. A joint is defined here as a gap where the edges of film element 2 and in-mold-coating layer 8 contact one another.

FIG. 2 illustrates diagrammatically the dimensions for the description of joint geometries. An enlarged detail of the front side of the injection-molded element is shown, where the film element 2 and the in-mold-coating layer 8 meet one another. The joint depth 100 here is the vertical dimension from the deepest point of the joint to an imaginary continuous of the surfaces of the film element 2 and in-mold-coating layer 8. In the event that the surfaces outside of the joint region are not flush with one another, a surface average is selected as reference plane. The joint width 200 is measured at right angles to the boundary between film element 2 and in-mold-coating layer 8.

FIGS. 3a and 3b are diagrams of initial phases in the process of the invention. A mold 3 has been provided, having a first mold half 4 and a second mold half 5. The first mold half 4 determines the shape of the front side, and the second mold half 5 determines the shape of the reverse side of the injection-molded element to be produced. As can be discerned from the dimensions of the depression in the first mold half 4 and of the projection in the second mold half 5, a cavity 6 is defined when the mold 3 is closed. A thermoplastic polymer can be introduced into this cavity 6 by way of the injection duct 10.

The film element 2 intended for in-mold coating has moreover been placed into the first mold half 4. A temperature control element 9, which is equipped for the heating and cooling of the entire back wall of the mold half (FIG. 3a), or of a predetermined edge area of the film element 4 (FIG. 3b), and has been integrated into the first mold half 4. The temperature-control element 9 can take the form of ducts. Running below the mold surface, there can be a plurality of bores through which a fluid is conveyed which ensures that the mold surface is maintained at a predetermined, as far as possible constant, temperature.

A temperature-control element 9 for dynamic temperature control of a selected film region can optionally likewise have ducts through which a hotter/colder fluid is conveyed in a separate circuit. Alternatively, temperature-control elements in the form of electrical resistance heating systems, or inductive methods, can also be used for local heating of the surface, which in turn can be cooled by way of cooling bores 9a which are close to the surface and through which cold water is conveyed.

In order to achieve a better appearance of the injection-molded element, it is preferable that this temperature-control element 9 is located below the surface of the first mold half 4. Transport of heat from temperature-control element 9 to film element 2 then takes place through the material present between said elements, which is part of the first mold half. In order to save energy and to increase the precision of heating, the material between said elements is selected to be as thin as possible, its thickness by way of example being ≤15 mm and preferably ≤10 mm.

FIGS. 4a and 4b are diagrams of a second phase in the process of the invention, starting from the configurations from FIG. 3a and FIG. 3b. The mold 3 is closed, and plastified thermoplastic material 7 has been injected by way of duct 10 into the cavity defined between first mold half 4 and second mold half 5, thus configuring an in-mold-coating layer.

FIG. 5 is a diagrammatic plan view of a first mold half 4 of a mold of the invention for use in the process of the invention. A film element 2 has been placed into the first mold half. The film element 2 has an edge 2′ and an inner edge region. The inner edge region extends from the edge 2′ over the length of the distance d1 (at right angles from the relevant position on the edge 2) in the direction of the film element 2.

The film element 2 moreover has an exterior edge region, defined with the aid of the distance d2 in a manner analogous to that for the inner edge region.

The first mold half 4 moreover has the temperature-control element 9 which, as described above, has preferably been integrated within this mold half. The temperature-control element 9 is not equipped to heat the entire area of the film element. Instead, the temperature-control element 9 follows the edge 2′ of the film element 2 with an additional extent in the direction of the film element 2 (distance d1) and away from the film element (distance d2). The extent of the temperature-control element 9 in the direction of the film element 2 is indicated by the reference sign 9′. In the drawing in FIG. 5, the delimited area of the inner edge of the film element 2 coincides with the extent 9′ of the temperature-control element 9 in the direction of the film element 2.

### EXAMPLES

The invention is illustrated in detail by the examples which follow, but is not restricted thereto.

### Materials Used:

Material for the in-mold-coating layer: Makrolon® 2405 from Covestro Deutschland AG. Aromatic polycarbonate based on bisphenol A with MVR of 19 cm³/(10 min), determined at 300° C. with 1.2 kg load in accordance with DIN ISO 1133:2012-03, and with Vicat softening point of 145° C., determined with 50 N at 50° C./h in accordance with DIN ISO 306:2014-03. The polycarbonate was pretreated by drying in dry air for 4 hours at 110° C.

### Material for the Film Elements:

Makrofol® DE 1-4 from Covestro Deutschland AG, based on bisphenol A-polycarbonate (MVR 6.0 cm³/(10 min), determined in accordance with DIN ISO 1133:2012-03, at 300° C. with 1.2 kg load). Vicat softening point, determined in accordance with DIN ISO 306:2014 method B at 120 K/h of heating time, was 150° C.
Makrofol® DE 1-1 from Covestro Deutschland AG, based on bisphenol A polycarbonate (MVR 6.0 cm³/(10 min), determined in accordance with DIN ISO 1133:2012-03, at 300° C. with 1.2 kg load), single-color-printed with NORIPLAN® HTR N L 67628 ink from Pröll KG, Germany. Vicat softening point, determined in accordance with DIN ISO 306:2014 method B at 120 K/h of heating time, was 150° C.
Bayfol® CR 210 from Covestro Deutschland AG, based on a blend of bisphenol A-polycarbonate (MVR 6.0 cm³/(10 min), determined in accordance with DIN ISO 1133:2012-03, at 300° C. with 1.2 kg) and polyethylene terephthalate copolyester. Vicat softening point, determined in accordance with DIN ISO 306:2014 method B at 120 K/h of heating time, was 127° C.
Makrofol® DE202 1-4 from Covestro Deutschland AG, based on a copolycarbonate of bisphenol A polycarbonate and bisphenol TMC polycarbonate (MVR 18 cm³/(10 min), determined in accordance with DIN ISO 1133:2012-03, at 300° C. with 1.2 kg load). Vicat softening point, determined in accordance with DIN ISO 306:2014 method B at 120 K/h of heating time, was 183° C.
Makrofol® UV 503 9-2 from Covestro Deutschland AG, a red-colored coextruded film based on bisphenol A polycarbonate (MVR 12 cm³/(10 min), determined in accordance with DIN ISO 1133:2012-03, at 300° C. with 1.2 kg load). Vicat softening point, determined in accordance with DIN ISO 306:2014 method B at 120 K/h of heating time, was 145° C.
Makrofol® UV 244 1-1 from Covestro Deutschland AG, a coextruded film based on bisphenol A polycarbonate (MVR 6.0 cm³/(10 min), determined in accordance with DIN ISO 1133:2012-03, at 300° C. with 1.2 kg load), with a functional layer for protection from UV radiation, and with integrating heating wires. Vicat softening point, determined in accordance with DIN ISO 306:2014 method B at 120 K/h of heating time, was 145° C.

### Production of Injection-Molded Elements:

### Comparative Examples

An injection-molded element with dimensions 150×105×4 mm was produced in an Arburg 570C injection-molding machine. For this, a polycarbonate-based film (see table A) as film element with dimensions 70×120 mm was placed into the first mold half of a steel mold in a manner such that in the finished molding it is adjacent to the upper edge and in other respects is placed in the middle with a free edge measuring about 15 mm in relation to the two lateral edges and 40 mm in relation to the lower edge of the molding. The film was fixed by adhesion on the polished surface. The temperature of the mold wall was 100° C. on the ejector side (first mold half) and 80° C. on the opposite nozzle side (second mold half).

After the two mold halves have been closed to form the mold, the in-mold-coating material Makrolon® 2405 was injected with a maximal injection pressure of about 2500 bar into the mold. The temperature of the polycarbonate melt here was 310° C. Injection time was 3.5 seconds. After a hold-pressure time of 8 seconds (hold pressure: 900 bar) and a cooling time of 25 seconds the mold was opened and the molding was removed.

### Inventive Examples

An injection-molded element with dimensions 150×105×4 mm was produced in an Arburg 570C injection-molding machine. For this, a polycarbonate-based film (see table B) as film element with dimensions 70×120 mm was placed into the first mold half of a steel mold in a manner such that in the finished molding it is adjacent to the upper edge and in other respects is placed in the middle with a free edge measuring about 15 mm in relation to the two lateral edges and 40 mm in relation to the lower edge of the molding. The film was fixed by adhesion on the polished surface, or in the case of films of thickness 500 μm or more was fixed in the cavity with the aid of small piece of double-sided adhesive tape. The temperature of the mold wall was 100° C. on the ejector side (first mold half) and 80° C. on the opposite nozzle side (second mold half).

After the two mold halves were closed to form the mold, the first mold half was heated to a measured temperature (for data see results table) by means of water-cooling (input temperature 20° C. above the desired temperature) within a heating time, and at the same time the in-mold-coating material Makrolon® 2405 was injected with a maximum injection pressure of 2500 bar into the mold. The temperature of the polycarbonate melt here was 310° C. Injection time was 3.5 seconds. After a hold-pressure time of 8 seconds (hold pressure: 900 bar) the mold wall was cooled within 8 seconds to a measured temperature 100° C. After a cooling time of 25 seconds, the mold was opened and the molding was removed.

### Subsequent Coating of the Injection-Molded Elements:

All of the solvents were purchased as technical-grade products and were used without drying.

### Pretreatment/Cleaning of Sample Components

Ionized air was blown onto the polycarbonate sheets (injected-molded element) in order to remove adhering contaminants before coating.

### Method for Subsequent Coating

Coating took place in a coating chamber under controlled conditions of temperature and humidity, in accordance with the respective instructions of the outer-coating material manufacturer, at 23 to 25° C. and at 40% to 48% relative humidity.

The sample sheets were cleaned with what are known as iso-wipes (LymSat® from LymTech Scientific; saturated with 70% by weight of isopropanol and 30% by weight of deionized water), rinsed with isopropanol, and dried in air for 30 minutes; ionized air was then blown onto the samples.

The primers and outer coatings are processed in accordance with manufacturer's instructions. The solids content of the commercially obtainable high-build primer SHP 470 FT 2050 from Momentive Performance Materials was adjusted with a 1:1 solvent mixture of diacetone alcohol and 1-methoxy-2-propanol to 5.2%, measured by the method below.

The solids content of the outer coatings was determined with the aid of the Mettler Toledo HB43 solids tester, a weighed sample of outer coating being evaporated to constant mass at 140° C. Percentage solids content is then calculated from the ratio of mass after to mass before evaporation. The solids content of the outer coating after curing of the outer coating here in the simplest case is the weight of outer coating minus the weight of solvent.

This primer was applied by the flow-coating process to one side of the polycarbonate sheets produced by in-mold coating of films.

A manual coating method was used. This involved pouring the liquid SHP470 primer coating solution over the sheet starting from the upper edge of the injection-molded element in longitudinal direction across the sheet, while the point of application of the primer on the sheet was simultaneously moved from left to right across the width of the sheet. The primed sheet, suspended vertically from a clamp, was air-dried for 30 minutes at 23° C. until dust no longer adhered to the surface, and was then cured for 60 minutes at 130° C.

After cooling to room temperature, the primed surface was coated with commercially obtainable AS 4700 F from Momentive Performance Materials.

The solids content of the AS 4700 was adjusted with a 1:1 solvent mixture of isopropanol and n-butanol to 25.0%, measured by the above method.

Application was likewise by a manual method. This involved pouring the liquid AS 4700 outer coating over the sheet starting from the upper edge of the injection-molded element in longitudinal direction across the sheet, while the point of application of the outer coating on the sheet was simultaneously moved from left to right across the width of the sheet. The outer-coated sheets, suspended vertically from a clamp, were air-dried for 30 minutes at 22° C. and were then cured for 60 minutes at 130° C.

### Visual Assessment:

The sample sheets were visually assessed after coating and evaluated by using a scale of 0 to 6, 0 being the best value and 6 being the worst value. The test investigated whether there is a visible gap at the boundary between film element and in-mold-coating material. The results are shown in the table below.

| | | | Makrofol ® | | | | | | Makrofol ® |
|---|---|---|---|---|---|---|---|---|---|
| | | | DE 1-1, | | | | | | DE 1-4, |
| | Makrofol ® | Makrofol ® | printed with | Makrofol ® | Bayfol ® | Makrofol ® | Makrofol ® | Makrofol ® | thickness 250 μm |
| | DE 1-4 | DE 1-4 | NORIPLAN ® | DE 1-4 | CR 210 | DE202 1-4 | UV 503 9-2 | UV 244 1-1 | with double |
| | thickness | thickness | HTR N L 67628 | thickness | thickness | thickness | thickness | thickness | hold-pressure |
| Film element | 250 μm | 300 μm | thickness 250 μm | 500 μm | 250 μm | 125 μm | 700 μm | 375 μm | time |
| Example | B1 | B2 | B3 | B4 | B5 | B6 | B7 | C | D |
| Without | 6 | 6 | 6 | 6 | 6 | 6 | — | — | — |
| heating | | | | | | | | | |
| Heating | | | | | | | | | |
| temperature | | | | | | | | | |
| [° C.] | | | | | | | | | |
| 153 | 1 (2) | 3 | 3 | 2-3 | 2 | 4 | 2 | 3 | — |
| 161 | 1 (2) | 2 | 2 | 2 | 2 | 2 | 2 | 2 | — |
| 170 | 1 | 2 | 1 | 2 | 2 | 2 | 1 (2) | 2 1 | |
| 178 | 1 | 1 | 1 | 1 | 2 | 1 | 1 | 1 | — |
| 186 | 1 | 1 | 1 | 1 | 1 (2) | 1 | 1 | 1 | — |

The grading criteria are as follows: 0: no boundary detectable; 1: film/substrate boundary detectable only with use of mirror techniques; 2: film/substrate boundary only just discernible; 3: film/substrate boundary readily discernible; 4: film/substrate boundary discernible, but no gap visible; 5: visible gap; 6: very clearly visible gap.

A grade of 3 or better is considered to indicate a pass in the visual assessment. All of the examples without heating are comparative examples.

The difference between the heating temperatures and the Vicat softening points of the film materials used is shown below:

| | Heating temperature [° C.] | | | | |
|---|---|---|---|---|---|
| | 153 | 161 | 170 | 178 | 186 |
| Makrofol/ | Difference between heating temperature | | | | |
| Bayfol | and Vicat softening point [° C.] | | | | |
| DE 1-4 | 3 | 13 | 20 | 28 | 36 |
| DE 1-1 | 3 | 13 | 20 | 28 | 36 |
| CR210 | 26 | 34 | 43 | 51 | 59 |
| DE202 1-4 | −30 | −22 | −13 | −5 | 3 |
| UV 503 9-2 | 8 | 16 | 25 | 33 | 41 |
| UV 244 1-1 | 8 | 16 | 25 | 33 | 41 |

Examples with heating are inventive, except for example B6 with 153° C. and 161° C. heating temperature.

Dynamic temperature control achieved sample sheets which had no discernible gap and almost no discernible boundaries between film element and in-mold-coating material.

The sample sheets without dynamic temperature control exhibited clear boundaries between film element and in-mold-coating material. Slight blistering was visible in the gap, due to evaporating solvent after film-formation.

### Microscopic Studies:

Microscopic studies were then carried out on microtome sections of the film element/in-mold-coating material boundary regions. For this, a sample including the boundary region is sawn from the sample sheet. A HM 355 S microtome from Microm is used to achieve straight cutting of said sample. This section is then photographed and measured under a DM 2700M microscope from Leica with 500× magnification in incident light in bright-field mode.

FIG. 6 shows a micrograph of the cross section of a comparative sample not produced by the process of the invention: example B1 without heating. The in-mold-coating layer is in the left-hand half of the image, and the film element is in the right-hand half of the image. With reference to the terminology in FIG. 2, the joint depth is 147 μm and the joint width is 145 μm.

FIG. 7 shows a micrograph of the cross section of a sample produced by the process of the invention: example B1 with heating to 170° C. The in-mold-coating layer is in the right-hand half of the image, and the film element is in the left-hand half of the image. The bond between them is jointless.

Dynamic temperature control significantly reduces peripheral gap formation. No coating defects can be seen.

The sample sheets without dynamic temperature control exhibited a clear gap between the film element and the in-mold-coating material (see table below). The coating filled this notch region to some extent or completely. The critical outer-coating thicknesses were thus exceeded, and this resulted in incomplete evaporation, which leads to blistering during curing. Slight blistering due to evaporating solvent was moreover apparent in the boundary region after film-formation. In addition to the above, excessive thicknesses of outer coating usually signify brittle regions and lead to reduced lifetime.

| | | | | | Makrofol ® | | | | | | | | | | | | Makrofol ® | |
|---|---|---|---|---|---|---|---|---|---|---|---|---|---|---|---|---|---|---|
| | | | | | DE 1-1, | | | | | | | | | | | | DE 1-4, | |
| | Makrofol ® | | Makrofol ® | | printed with | | Makrofol ® | | Bayfol ® | | Makrofol ® | | Makrofol ® | | Makrofol ® | | thickness | |
| | DE 1-4 | | DE 1-4 | | NORIPLAN ® | | DE 1-4 | | CR 210 | | DE202 1-4 | | UV 503 9-2 | | UV 244 1-1 | | 250 μm with | |
| Film | thickness | | thickness | | HTR N L 67628 | | thickness | | thickness | | thickness | | thickness | | thickness | | double hold- | |
| element | 250 μm | | 300 μm | | thickness 250 μm | | 500 μm | | 250 μm | | 125 μm | | 700 μm | | 375 μm | | pressure time | |
| Example | B1 | | B2 | | B3 | | B4 | | B5 | | B6 | | B7 | | C | | D | |
| | Gap | uwd | Gap | uwd | Gap | uwd | Gap | uwd | Gap | uwd | Gap | uwd | Gap | uwd | Gap | uwd | Gap | uwd |
| Without | 147 | 145 | 160 | 115 | 110 | 136 | >200 | 201 | 82 | 125 | 125 | 133 | | | | | | |
| heating | | | | | | | | | | | | | | | | | | |
| Heating | | | | | | | | | | | | | | | | | | |
| temperature | | | | | | | | | | | | | | | | | | |
| [° C.] | | | | | | | | | | | | | | | | | | |
| 153 | 28 | 4 | <3 | 5 | <3 | <3 | | | | | 125 | <3 | | | 4 | <3 | | |
| 161 | 15 | <3 | | | | | | | | | 125 | <3 | | | | | | |
| 170 | <3 | <3 | <3 | <3 | | | <3 | <3 | <3 | <3 | <3 | <3 | 5 | <3 | <3 | <3 | <3 | <3 |
| 178 | <3 | 4 | | | | | | | | | | | | | | | | |
| 186 | <3 | <3 | <3 | <3 | | | | | | | | | | | <3 | <3 | | |

Gap: depth of gap starting from surface; corresponds to dimension with reference sign 100 in FIG. 2
uwd: upper defect width; corresponds to dimension with reference sign 200 in FIG. 2

1. A process for the production of an injection-molded element (1) with a front side and a reverse side, where there is, arranged on the front side of the injection-molded element (1), a film element (2) flush with the surface of an in-mold-coating layer (8),
wherein the film element (2) has an edge (2′) and defines an inner edge region which extends from the edge (2′) over a predetermined distance d1 running at right angles to the edge in the direction of the film element (2), where d1 is smaller than half of the width of the film element (2)
and wherein the process comprises the following steps in this sequence:
providing a mold (3) which in the closed state defines, between a first mold half (4) which replicates the front side of the injection-molded element (1) and a second mold half (5) which replicates the reverse side of the injection-molded element (1), a cavity (6) configured in a manner complementary to the injection-molded element (1),
placing the film element (2) into the first mold half (4),
closing the mold (3),
injecting a plastified thermoplastic material (7) into the cavity (6) in order to configure an in-mold-film coating layer (8),
allowing the plastics material (7) to solidify,
opening the mold (3) and
removing the injection-molded element (1),
wherein the thickness of the film element (2) is ≥20 μm to ≤1000 μm,
wherein the film element (2) covers only a partial region in the first mold half (4),
and wherein at least during one portion of the injection of the plastified thermoplastic material (7) at least the inner edge region of the film element (2) is heated by one or more temperature-controlled elements (9) present in the first mold half (4) at least to a temperature T of 20° C. below the Vicat softening point (determined in accordance with DIN ISO 306:2014 method B at 120 K/h of heating time) of the material of the film element (2).

2. The process of claim 1, wherein locally restricted heating of the mold is achieved by means of dynamic temperature control at the film element/in-mold-coating material boundary.

3. The process of claim 1, wherein regions of the film element (2) that do not belong to the inner edge region are not heated to the temperature T.

4. The process of claim 1, wherein the predetermined distance d1 is ≥1% to ≤40% of the width of the film element (2).

5. The process of claim 1, wherein the film element (2) further defines an outer edge region which extends from the edge (2′) over a predetermined distance d2 running at right angles to the edge in the direction away from the film element (2), wherein d2 is ≥1% to ≤40% of the width of the film element (2), and wherein, in the first mold half (4), sections corresponding to the outer edge region are heated together with the inner edge region to the temperature T.

6. The process of claim 1, wherein the thermoplastic material (7) or the material of the film element (2) comprise a polycarbonate.

7. The process of claim 1, wherein the film element (2) is a heating film, a film with projection function, a film with scattering function, a colored film, a film with optically discernible surface structure, a film comprising functional additives, a film with antireflective function, a film with anti-fingerprint function, a film with antiglare function, a film with antifogging function, a film with increased chemical resistance to the in-mold-coating material, a film with barrier function, an IR-reflective film, a film with absorption properties, a polarizing film, a metallized film or a super retardation film.

8. The process of claim 1, wherein the thickness of the film element (2) is ≥100 μm to ≤700 μm.

9. The process of claim 1, further comprising, after removal of the injection-molded element (1), a subsequent coating of at least the component side on which the film element (2) is present.

10. An injection-molded element (1), produced by the process of claim 1, with a front side and a reverse side,
where there is, arranged on the front side of the injection-molded element (1), a film element (2) flush with the surface of an in-mold-coating layer (8),
where the film element (2) covers only one portion of the surface of the in-mold-coating layer (8),
and where the film element (2) and the in-mold-coating layer (8) respectively comprise a thermoplastic polymer,
wherein the bonding of the film element (2) to the in-mold-coating layer (8) is jointless,
or in the event that a joint is present between film element (2) and in-mold-coating layer (8), the depth (100) of this joint is ≤12% of the thickness of the film element (2) or the width (200) of said joint is ≤12% of the thickness of the film element (2).

11. The injection-molded element (1) of claim 10, where the film element (2) is a heating film, a film with projection function, a film with scattering function, a colored film, a film with optically discernible surface structure, a film comprising functional additives, a film with antireflective function, a film with anti-fingerprint function, a film with antiglare function, a film with antifogging function, a film with increased chemical resistance to the in-mold-coating material, a film with barrier function, an IR-reflective film, a film with absorption properties, a polarizing film, a metallized film or a super retardation film.

12. The injection-molded element (1) of claim 10, wherein the injection-molded element (1) is a glazing element, a transparent covering or a cladding element, and the film element (2) is a heating film.

13. (canceled)
